(19) United States
(12) Patent Application Publication
(10) Pub. No.: US 2016/0219628 A1
(43) Pub. Date: Jul. 28, 2016

(54) Dynamic Group Communication Participant Preemption Ranking

(71) Applicant: QUALCOMM Incorporated, San Diego, CA (US)

(72) Inventors: Sandeep Sharma, San Diego, CA (US); Nivedita Sarkar, San Diego, CA (US); Vijay Anandrao Suryavanshi, San Diego, CA (US)

(21) Appl. No.: 14/607,353

(22) Filed: Jan. 28, 2015

(51) Int. Cl. H04W 76/00; H04W 4/10

(52) U.S. Cl. CPC H04W 76/005; H04W 4/10

(57) ABSTRACT

Methods, servers, and systems enable the management of a group communication session among participants. A server may determine a preemption rank for preempting a floor from a floor-holding participant based on a pre-established relational modifier or an administrative relational modifier. The pre-established relational modifier may be based on whether an individual participant has a pre-established relationship to the floor-holding participant. The administrative relational modifier may be based on an assigned relationship between the individual participant and another participant. The server may process a floor request received from a requesting participant that is not the floor-holding participant. In addition, the server may determine whether to grant the floor request based on the preemption rank of the floor-holding participant and the requesting participant. Further, the server may initiate a request response transmission in response to determining to grant the floor request.

### BACKGROUND

Mobile devices are often utilized to participate in a group communication session. In some arrangements, one participant at a time is given priority to speak over the other participants, such as in push-to-talk (PTT) sessions. Such a priority to talk is typically referred to as a “floor grant,” where no other group participant of the PTT session can be heard until the mobile device with the floor grant (i.e., the floor-holding participant) has the floor taken away or releases the floor. In addition, PTT solutions and standards provide the concept of a “preemption rank,” in which a given group communication participant may assert a higher rank over the floor-holding participant, if the floor-holding participant has a lower rank. The preemption ranks may be based on static parameters of each participant, such as a participant's position, status, or hierarchy among the group. However, various group communication settings may benefit from a system in which preemption ranks dynamically change based on further considerations.

### SUMMARY

The various embodiments may include a method for enabling the management of a group communication session among a plurality of participants in a group communication session. In various embodiments, a processor may determine a preemption rank for preempting a floor from a floor-holding participant based on a pre-established relational modifier or an administrative relational modifier. The pre-established relational modifier may be based on whether an individual participant for which the preemption rank is determined has a pre-established relationship to the floor-holding participant. The administrative relational modifier may be based on an assigned relationship between the individual participant for which the preemption rank is determined and another participant. The processor may process a floor request received from a requesting participant that is not the floor-holding participant. In addition, the processor may determine whether to grant the floor request based on the preemption rank of the floor-holding participant and the requesting participant. Further, the processor may initiate a request response transmission in response to determining to grant the floor request.

In some embodiments the preemption rank may be based on whether the individual participant for which the preemption rank is determined has the pre-established relationship to the floor-holding participant. The individual participant having the pre-established relationship to the floor-holding participant may increase the preemption rank of the individual participant while the floor-holding participant holds the floor of the group communication session. The preemption rank may further be based on a geographic modifier based on a location of the individual participant for which the preemption rank is determined. The preemption rank may be further based on a geographic modifier determined by a location of the floor-holding participant. The preemption rank may be further based on whether the individual participant for which the preemption rank is determined has the pre-established relationship to the floor-holding participant. The preemption rank of the individual participant having the pre-established relationship to the floor-holding participant may be inversely proportional to a duration that the floor-holding participant holds the floor of the group communication session. The preemption rank of the individual participant for which the preemption rank is determined may be inversely proportional to a duration that the individual participant holds the floor of the group communication session. The pre-established relational modifier may not modify the preemption rank of the individual participant for which the preemption rank is determined. The administrative relational modifier may change the preemption rank of the individual participant for which the preemption rank is determined by a weighted function based on the preemption rank of another participant among the plurality of participants. The preemption rank may be based on the administrative relational modifier received while the group communication session is in progress. The preemption rank may be further based on a group quantity modifier. The group quantify modifier may be based on a quantity selected from the group including a total number of the plurality of participants, a number of participants in a sub-group of the plurality of participants, a number of sub-groups among the plurality of participants, a number of base ranks, a number of participants having a particular base rank, and a number of participants having a particular preemption rank.

Further embodiments may include a device having a processor configured with processor-executable instructions to perform various operations corresponding to the methods discussed above.

Further embodiments may include a non-transitory processor-readable storage medium having stored thereon processor-executable instructions configured to cause a processor to perform various operations corresponding to the method operations discussed above.

Further embodiments may include a device having various means for performing functions corresponding to the method operations discussed above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of a communication system suitable for use with various embodiments.

FIG. 2 is a timeline illustrating embodiment methods of managing a group communication session using relational modifiers.

FIG. 3 is a geographic diagram illustrating an embodiment method of managing a group communication session using geo-fence modifiers.

FIG. 4 is a timeline illustrating embodiment methods of managing a group communication session using relational modifiers.

FIGS. 5A and 5B are geographic diagrams illustrating an embodiment method of managing a group communication session using geo-fence modifiers.

FIG. 6 is a timeline illustrating embodiment methods of managing a group communication session using geo-centric modifiers.

FIG. 7 is a timeline illustrating embodiment methods of managing a group communication session using temporal modifiers.

FIG. 8 is a timeline illustrating embodiment methods of managing a group communication session using lingering floor requests.

FIGS. 9A-C illustrate a Press-to-Transmit (PTX) administrator device with a user interface for entering administrative relational modifiers suitable for use in various embodiments.

FIG. 10 is a process flow illustrating a method of managing a group communication session suitable for use in various embodiments.

FIG. 11 is a process flow illustrating a method of managing a group communication session suitable for use in various embodiments.

FIG. 12 is a component block diagram of a communication device suitable for use in various embodiments.

FIG. 13 is a component block diagram of a server suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Various embodiments provide methods, devices, and systems for managing a group communication session having a floor-holding participant among a plurality of participants. A preemption rank, determined for each participant of the plurality of participants in the group communication, may be used for preempting the floor from the floor-holding participant. The preemption ranks may be based on one or more rank modifiers. The rank modifiers may include a pre-established relational modifier and/or an administrative relational modifier. The pre-established relational modifier may be based on whether an individual participant for which the preemption rank is determined has a pre-established relationship to the floor-holding participant. The administrative relational modifier may be based on an assigned relationship between an individual participant for which the preemption rank is determined and another participant among the plurality of participants. During the group communication session, the determined preemption ranks may be used to determine whether to grant floor requests from participants wanting to preempt the floor.

The word “exemplary” is used herein to mean “serving as an example, instance, or illustration.” Any implementation described herein as “exemplary” is not necessarily to be construed as preferred or advantageous over other implementations.

The expression “group communication session,” as used herein refers a multi-participant telecommunication session, particularly a telecommunication session configured and conducted so that one participant has the floor to speak (referred to herein as a “floor-holding participant”) while a plurality of other participants listen. The terms “Press-to-Transmit,” “PTX,” “Push-To-Talk,” or “PTT” are used herein interchangeably to refer to group communication sessions that provides an always-on connection or at least virtually always-on, like a “walkie-talkie.” Traditional PTT may use half-duplex communications, meaning communications may only travel in one direction at any given moment so that only one participant (the floor-holding participant) may be heard at a time. A form of PTT messaging that enables the exchange of video is referred to as “Press-to-Transmit” or “PTX.” PTX may allow one communication group member to make video images available to the entire group. PTX as used herein may use full duplex with controls over which communication group member(s) may have priority over a channel of communication. The expression “press-to-transmit” takes into account the fact that modern mobile communication devices often have touch-screen interfaces that only require a “press” of a finger, rather than a push. The video images may be stills or motion video and are similarly considered message segments. PTX communications may include audio or may be silent. Thus, PTX may be considered a more generic term for group communications of this type that exchange at least one of audio, video, and data messaging.

A PTX message segment refers to a communication segment that includes an audio and/or video transmission generating by a user. The PTX message segment includes more than just signaling data and thus includes the substantive part of the message transmitted from that user to other members of the PTX group. The message transmitted may include an audio transmission, such as a “talk spurt,” a video transmission or a combination of these. In the descriptions of the various embodiments, while the messages may be referred to in terms of one or more audio segments, it should be understood that such messages may include or exclusively consist of video messages or other media streaming content intended for continuous live broadcast.

As used herein, a “pre-established relationship” refers to a participant being connected through relation, association, affiliation, or other pre-defined virtual link to another participant. The pre-established relationship may be recognized in advance of establishing the group communication session or at least prior to determining a preemption rank. Also, the pre-established relationship may be a professional, social (e.g., through a social network), familial, or other association common to at least two participants. While the group communication session itself links the plurality of participants, the pre-established relationship is an additional link between two or more particular participants. For example, some participants may be co-workers or have a common chain-of-command.

As used herein an “ad hoc relationship” refers to a participant having a preemption rank link to another participant that is established for the special purpose of a particular communication session or established to meet an immediate need. For example, after establishing a communication session, an administrative participant may modify the rank of an independent participant by applying an ad hoc relational modifier to the rank or priority of the independent participant. The ad hoc relational modifier may establish an ad hoc relationship to a participant with a known base rank and thus boost the rank of the independent participant who otherwise has no pre-established relationship with other participants in the group. Alternatively, the administrative participant may use the ad hoc relational modifier to adjust the preemption rank of a participant who already has a pre-established relationship, such as to accommodate special circumstances.

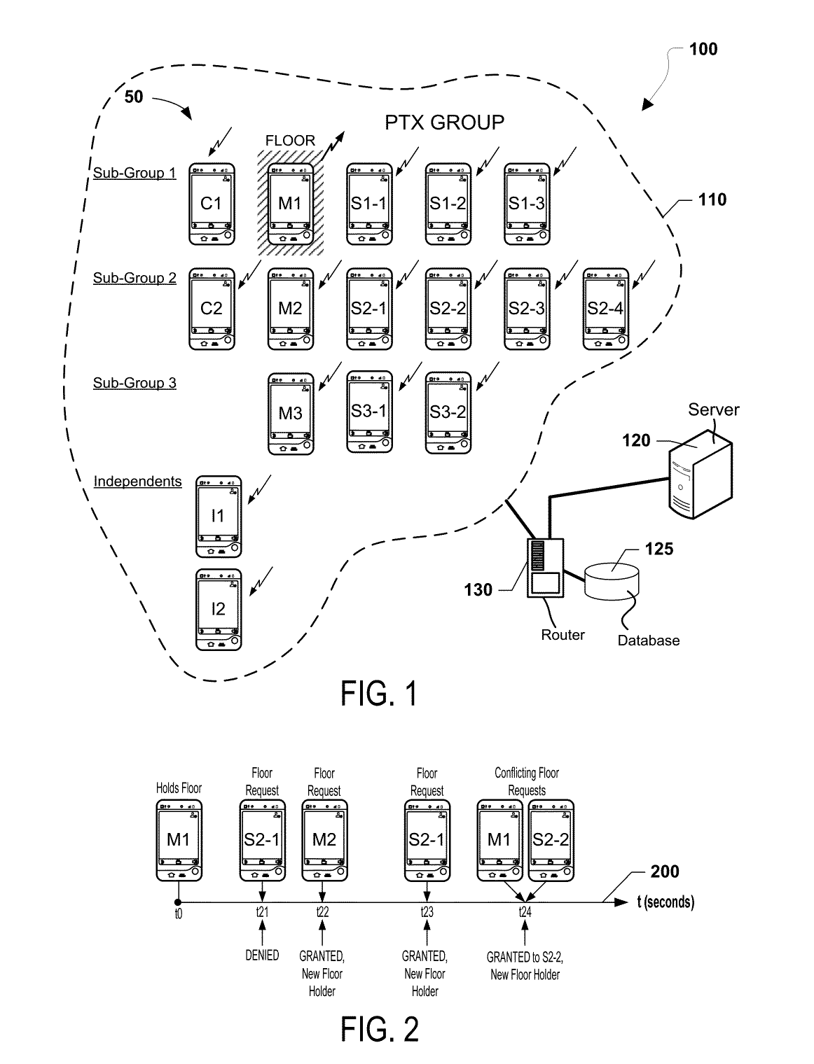

FIG. 1 illustrates an embodiment system 100 for managing a group communication session among a plurality of participants. The participants each access the group communication session through a communication device configured to connect to a communication network 110. Through shared or separate access points, each communication device may connect to the group communication session as part of a PTX group.

The communication devices 50 are all illustrated as the same type of device for ease of illustration, but some or all may differ. For example, the communication devices may be one or more cellular telephones, personal or mobile multi-media players, personal data assistants (PDA's), laptop computers, tablet computers, smartbooks, palm-top computers, wireless electronic mail receivers, multimedia Internet enabled cellular telephones, wireless gaming controllers, and similar personal electronic devices which include a programmable processor and memory and may include software and/or hardware to enable group communications, such as with PTX functionality.

In the system 100, as part of the group communication session, each communication device may be capable of receiving and, to a more limited extent, transmitting communications across the communication network 110 with other participants of the group communication session. Individual participants associated with each of the communication devices 50 are differentiated in FIG. 1 by a unique identifier (i.e., C1, M1, S1-1, S1-2, S1-3; C2, M2, S2-1, S2-2, S2-3, S2-4; and M3, S3-1, S3-2). For ease or reference to the illustrated example, the first number appearing after a letter on the display of each communication device represents that participant's pre-established sub-group and the number after the dash, if applicable, distinguishes participants of equal title/level within a sub-group. A surrounding crosshatched field and title “FLOOR” distinguishes a floor-holding participant M1 from the non-floor-holding participants in the PTX group.

In the various embodiments, the communication devices 50 may individually communicate with a server 120 such as through a router 130, across the communication network 110. The server 120, which may be present on a server-side network, may share information, including group communications, with the communication devices 50 designated by an originating group communication device (i.e., one of the group communication devices that established the group communication session). The server 120 may also share information with the communication devices accessible to the server 120, across either the communication network 110 or another network. The server 120 may have an attached or accessible database 125 to store group data and/or buffer message segments. In addition, some or all of the functions of the server 120, the router 130, and the database 125 may be combined in a single device.

In various embodiments, communication devices 50 may be a group of select devices between which the server 120 establishes PTX channels for communications. Such communications may occur through, or at the control of, the server 120. However, all data packets of the devices do not necessarily have to travel through the server 120. In various embodiments the server 120 may be able to control the communication because it may be the main server-side component that is aware of and/or can retrieve the identity of the participants of the communication group. Alternatively, a participant of the group may direct the identity of the participants or provisioning for the communication group to the server 120 or another computing device. A PTX channel may be established through a half-duplex channel (true or virtual) between the communication devices 50. The server 120 may also inform one or more of the communication devices 50 when other communication devices designated to be part of the group cannot be reached. While the server 120 is shown here as having the attached database 125, the server 120 may have its own data storage and database functions.

In various embodiments, the server 120 may be configured to receive the data packages from the communication devices 50 and selectively permit members of the PTX group to receive the stored data packages across the communication network 110. In an embodiment, data packages may include, but are not limited to, pictures in JPEG, TIF, and the like, video files such as flash video, AVI, MOV, MP4, MPG, WMV, 3GP and the like, audio files such as MP3, MP4, WAV, and the like, documents, and/or presentations. The data packages may additionally include streaming media, such as a multimedia application (PowerPoint, MOV file, and the like). Also, the data packages may include half-duplex video conferencing among members of the communication group wherein the picture of the speaker may be broadcast to the other group members in substantial real-time, or in delay.

The communication network 110 may include a series of communications servers that control communications between the communication devices of the PTX group participants in a PTX system. The communication network 110 may include any system whereby remote modules communicate over-the-air between and among each other and/or between and among components of a wireless network, including, without limitation, wireless network carriers and/or servers. A series of communications servers may be connected to a group communication server. Such servers may be connected to a wireless service. The wireless network may control messages (generally in the form of data packets) sent to a messaging service controller.

The number of participants, sub-groups, and/or characteristics of the PTX group or sub-groups thereof are illustrated and described herein for illustrative purposes and are not intended to limit the scope of the claims. Thus, in accordance with various embodiments the number of participants, sub-groups, participants within sub-groups, titles, relationships, or other characteristics may vary.

In various embodiments, the server 120 may perform arbitration functions between competing demands of the various communication devices 50 for use or control of PTX communication channels over the communication network 110. For example, in response to a request from one communication device to communicate with the PTX group, the server 120 may establish a PTX channel between the requesting device and the communication devices 50 in the PTX group. The server 120 may thus grant control of the “floor” to the requesting communication device, at least initially. When a participant receives a floor grant and controls the floor that participant is considered a floor-holding participant M1. In a half duplex group communication session the floor-holding participant has priority to be heard over the non-floor-holding participants so only the floor-holding participant M1 may be heard by the PTX group. Similarly, in a communication session that includes video, the floor-holding participant M1 may have priority over what is visually distributed and presented to the PTX group. When competing requests occur amongst communication devices 50 for control of the “floor,” the server 120 may arbitrate between competing requests based on the preemption ranks of the communication devices.

The criteria for determining a preemption rank R_{P}, for each participant of the plurality of participants, may be pre-established, such as by a PTX administrator and stored in the server 120 and/or the database 125. The PTX administrator may not be a participant of the PTX group or may be an administrative participant of the plurality of participants that make up the PTX group. Once the criteria for determining a preemption rank R_{P} are established, the preemption rank may be determined. The determination regarding the preemption ranks may be performed before or during the communication session at regular intervals, continuously, or in response to a change in conditions influencing the preemption rank determinations.

In various embodiments, one or more rank modifiers R_{M} may be used to determine preemption ranks. In this way, a base rank R_{B} may be adjusted by one or more other values referred to as rank modifiers. The base rank may be a legacy static rank defined when provisioning the PTX group, and may be the same for all participants or different for individual participants or sub-groups of participants. In a simple example, all participants may have the same base rank or a nil value base rank, which means the rank modifier(s) associated with each individual participant may be the only thing differentiating the preemption ranks of the PTX group participants. More complex scenarios may include different base ranks and/or more than one rank modifier used to determine each participant's preemption rank.

The adjustment of the base rank R_{B} may be computed using additive, multiplicative, or other weighted functions. An example of an additive weighted function for determining each participant's preemption rank may be as follows:

R_{P}=R_{B}+Σ₁ⁿMᵢ (Equation 1),

where the individual participant preemption rank R_{P} is determined from a sum of n rank modifiers Mᵢ, where n is the number of rank modifiers added to the base rank R_{B}. Alternatively, an example of a multiplicative weighted function for determining each participant's preemption rank may be as follows:

R_{P}=R_{B}×Π₁ⁿMᵢ (Equation 2),

where the individual participant preemption rank R_{P} is determined from the product of n rank modifiers Mᵢ, where n is the number of rank modifiers multiplied with the base rank R_{B}.

The base rank may be an unchanging rank (i.e., a static rank) associated with particular participants, such as from a hierarchical priority given to certain PTX group participants. For example in FIG. 1, each of the three sub-groups (i.e., Sub-Group 1, Sub-Group 2, and Sub-Group 3) may have a hierarchical structure. Sub-Group 1 has a Chief C1, which may have a higher base rank than a Manager M1, who in-turn may have a higher base rank than the three Subordinates S1-1, S1-2, S1-3. Similarly, Sub-Group 2 has a Chief C2, a Manager M2, and four Subordinates S2-1, S2-2, S2-3, S2-4 with a similar hierarchical structure. In contrast, Sub-Group 3 does not have a chief, but does have a Manager M3, who may have a higher base rank than the two Subordinates S3-1, S3-2.

In setting up the group communication session, a call originator, a PTX administrator, or a computing device (e.g., a server) may set values associated with each base rank. In this way, each of the hierarchical positions (i.e., Chief, Manager, Subordinate, or Independents) may have a static base rank associated with that position; such as 10 for Chiefs, 5 for Managers, 1 for Subordinates, and 5 for Independents. Without considering any rank modifiers, the Chiefs C1, C2 may match each other in base rank but outrank everyone else. Similarly, the Managers M1, M2, M3 and Independents may match each other in base rank, outrank all the Subordinates, but are lower in base rank than the Chiefs. Assigning the independent participants I1, I2 to have more than a nominal base rank may allow them to preempt the floor on par with other participants. In setting up the group communication session, values associated with the base rank of the independent participants I1, I2 may allow them to preempt most participants, never allow them to preempt, or something in between.

In various embodiments, relational modifiers may be a type of rank modifier used to determine each participant's preemption rank. The relational modifier may increase or decrease the preemption rank of those participants that either have a pre-established relationship to the floor-holding participant or an ad hoc relationship assigned by an administrative participant.

With reference to FIG. 1, participants within each of the three sub-groups (e.g., Group 1, Group 2, and Group 3) may have a pre-established relationship to those other participants that share the same sub-group, if such sub-groups are recognized or defined when provisioning the group communication session. Thus, Group 1 participants C1, M1, S1-1, S1-2, S1-3 may have the pre-established relationship of being members of Group 1; Group 2 participants C2, M2, S2-1, S2-2, S2-3, S2-4 may have the pre-established relationship of being members of Group 2; and Group 3 participants M3, S3-1, S3-2 may have the pre-established relationship of being members of Group 3. These pre-established relationships may be the basis of a pre-established relational modifier M_{P}. In this way, when M1 is the floor-holding participant, the other members of Sub-Group 1 (i.e., C1, S1-1, S1-2, S1-3) may have their respective base rank modified accordingly. In this example, the two independent participants I1, I2, have no pre-established relationship with other participants, so the pre-established relational modifier does not apply to them. However, in order to establish some ability to preempt the floor, a group administrator may assign an administrative relational modifier M_{A} that gives the independent participants I1, I2 a similar rank to the base rank of another participant (e.g., M2). Alternatively, a server or processor of a communication device organizing a group communication session may be programmed to construct relationships when participants have no relationship to other participants. In this way, default administrative relational modifiers may be used for participants with no relationships or an incomplete set of relationships.

Table 1 below illustrates an example of preemption ranks determined using an additive weighted function in accordance with Equation 1. In this example, participants in the same group as the current floor-holding participant (e.g., M1) have the pre-established relational modifier M_{P} (e.g., a positive value of 5) included in calculating their respective preemption ranks. Alternatively, the value of the pre-established relational modifier M_{P} for an individual participant may be based on a percentage of a rank of the participant to whom they have the pre-established relationship. In addition, the preemption ranks in Table 1 include the base ranks for the hierarchical positions noted above (i.e., chief=10, manager=5, subordinate=1). By applying the pre-established relational modifier M_{P} in this way, the preemption rank R_{P} of the Sub-Group 1 subordinates S1-1, S1-2, S1-3 may be adjusted. In this illustrative example, the pre-established relational modifier M_{P} is set high enough to raise the preemption rank R_{P} of the Sub-Group 1 subordinates S1-1, S1-2, S1-3 above all the managers M1, M2, M3, both independents I1, I2, and all the other subordinates S2-1, S2-2, S2-3, S2-4, S3-1, S3-2. The number in parenthesis in Table 1 denotes an optional variant in which the floor-holding participant also benefits from the pre-established relational modifier M_{P}.

TABLE 1

| Participant | R_{B} (10/5/1) | M_{P} | M_{A} | R_{P} |
|---|---|---|---|---|
| C1 | 10 | 5 | n/a | 15 |
| M1 (Floor) | 5 | n/a (5) | n/a | 5 (10) |
| S1-1 | 1 | 5 | n/a | 6 |
| S1-2 | 1 | 5 | n/a | 6 |
| S1-3 | 1 | 5 | n/a | 6 |
| C2 | 10 | n/a | n/a | 10 |
| M2 | 5 | n/a | n/a | 5 |
| S2-1 | 1 | n/a | n/a | 1 |
| S2-2 | 1 | n/a | n/a | 1 |
| S2-3 | 1 | n/a | n/a | 1 |
| S2-4 | 1 | n/a | n/a | 1 |
| M3 | 5 | n/a | n/a | 5 |
| S3-1 | 1 | n/a | n/a | 1 |
| S3-2 | 1 | n/a | n/a | 1 |
| I1 | n/a | n/a | 5 | 5 |
| I2 | n/a | n/a | 5 | 5 |

Participants of the PTX group may also have more than one type of pre-established relationship with one another and the different types of pre-established relationships may cross between sub-groups or other pre-established relationships. For example, the Chiefs C1, C2 may have their own pre-established relationship based on rank that crosses between sub-groups. Also, the different types of pre-established relationship may have a different pre-established relational modifier associated with them. In this way, whether an individual participant has a pre-established relationship to the floor-holding participant may be a basis for modifying a preemption rank of that individual.

FIG. 2 illustrates a timeline 200 of an embodiment method of managing a group communication session using the pre-established relational modifier M_{P}. The timeline 200 demonstrates how a group communication participant's preemption rank may change over time when pre-established relational modifiers are used to determine the preemption rank of each participant. The timeline 200 uses the same PTX group described above with regard to FIG. 1 (e.g., communication devices 50). In addition, the same base rank and pre-established relational modifiers described above with regard to Table 1 (i.e., applying Equation 1) are used for this embodiment, at least at the start of the timeline 200. At the start of the timeline 200 (i.e., t0) the floor-holding participant is M1. While holding the floor, the floor-holding participant M1 may be heard by all other participants of the PTX group.

Sometime after the start, at the first point t21 along the timeline 200, a non-floor-holding participant S2-1 is shown making a floor request. The non-floor-holding participant S2-1 may press a “button” or other input element on his or her communication device to transmit a floor request to the server (e.g., server 120 in FIG. 1). Upon receipt of the floor request from the non-floor-holding participant S2-1, the server may determine a highest preemption rank between the floor-holding participant (i.e., MD and the one or more floor-requesting participants (i.e., participant S2-1).

The preemption ranks may be determined at the time of each floor request, whenever conditions effecting preemption ranks change, regularly, or continuously. In addition, once the preemption ranks are determined, the server may store those values in a database (e.g., database 125 in FIG. 1). In this way, when a floor request is made (e.g., at t21, t22, t23, t24) and the server needs to determine which participant currently has the highest preemption rank, the server may either spontaneously perform the necessary calculations or look them up in the database (e.g., a company directory or contact list). A database look-up may provide values similar to those included in Table 1. The server may thus determine whether to grant the floor request based on the preemption rank of the floor-holding participant (e.g., M1) and the requesting participant (e.g., S2-1).

The floor request may be granted when the requesting participant meets or exceeds the preemption rank of the floor-holding participant. Alternatively, the floor request may only be granted when the requesting participant has the higher preemption rank. Otherwise, the floor request may be denied when the requesting participant has a lower preemption rank than the floor-holding participant. As demonstrated by the values in Table 1, at the first point t21, participant M1 has a higher rank (e.g., R_{P}=R_{B}(5)+M_{P}(0)=5) than participant S2-1 (i.e., R_{P}=R_{B}(1)+M_{P}(0)=1), thus the floor request is denied.

At the second point t22 along the timeline 200, another non-floor-holding participant M2 is making a floor request. As demonstrated by the values in Table 1, M1 has the same rank (i.e., R_{P}=R_{B}(5)+M_{P}(0)=5) as M2 (i.e., R_{P}=R_{B}(5)+M_{P}(0)=5), thus this time the floor request may be granted, which means M2 is granted the floor (i.e., there is a new floor holder). This change in floor-holding participant from M1 to M2 may also change the preemption ranks of some or all participants. In particular, the participants in Group 1 (i.e., C1, S1-1, S1-2, and S1-3) no longer benefit from the pre-established relational modifier M_{P}, since they do not have a pre-established relationship with the new floor-holding participant M2. Also, the other participants in Group 2 (i.e., C2, S2-1, S2-2, S2-3, S2-4) now benefit from the pre-established relational modifier M_{P}, since they have a pre-established relationship with the new floor-holding participant M2. Thus, once participant M2 is granted the floor some values in Table 1 would change.

At the third point t23 along the timeline 200, participant S2-1 once again makes a floor request. When the floor-holding participant (e.g., M2 at the third point t23) does not gain the benefit of the pre-established relational modifier, as in this embodiment, the preemption rank of the floor-holding participant may be based only on a base rank or other rank modifier(s), if applicable. In contrast, at the third point t23, since participant S2-1 is a member of the same group as M2 (i.e., Group 2), participant S2-1 does gain the pre-established relational modifier. Thus, at the third point t23, participant S2-1 has a higher preemption rank (e.g., R_{P}=R_{B}(1)+M_{P}(5)=6) than participant M2, so participant S2-1 is granted the floor (i.e., there is a new floor holder). This time, although the floor-holding participant changes, the preemption ranks will only change for M2 and S2-1, since they are both members of the same group (i.e., Group 2). In particular, at or after the third point t3, with S2-1 now holding the floor, the benefit of the pre-established relational modifier M_{P} goes to participant M2, but no longer benefits participant S2-1.

At the fourth point t24 along the timeline 200, both participants M1 and S2-2 make conflicting floor requests. Conflicting floor requests occur when two or more participants either request the floor simultaneously or close in time to one another. A predetermined time interval may be established for determining how close in time multiple floor requests may be considered conflicting floor requests. For example, the server may consider requests received within a few seconds of one another as conflicting. Alternatively, a shorter or longer period may be designated as the predetermined time interval for conflicting floor requests. In the example at time point t24, although participant M1 has a higher preemption rank (e.g., R_{P}=R_{B}(5)+M_{P}(0)=5) than participant S2-1 (e.g., R_{P}=R_{B}(1)+M_{P}(0)=1), participant M1 would not have a higher preemption rank than participant S2-2 (e.g., R_{P}=R_{B}(1)+M_{P}(5)=6) who benefits from the pre-established relational modifier M_{P}. In this way, at point t24 participant S2-2 is granted the floor (i.e., there is once again a new floor holder).

Geographic Modifier

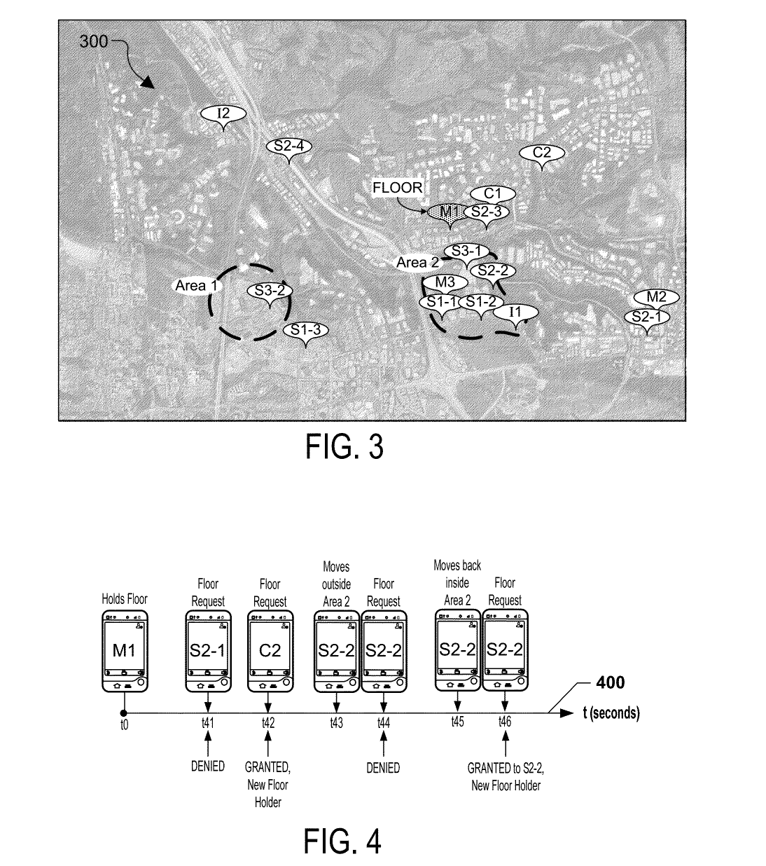

FIG. 3 illustrates an embodiment system 300 for managing a group communication session having a floor-holding participant among a plurality of participants. A uniquely labeled elliptical bubble with a downwardly protruding point indicates a location of each of the participants on an exemplary map. Similar to the embodiment system 100, described above with regard to FIG. 1, each participant may access the group communication session through a communication device configured to connect to a communication network. Through shared or separate access points, each communication device may connect to the group communication session as part of the PTX group. For ease of explanation, FIG. 3 includes the same participants described above with regard to FIGS. 1 and 2, each having similar static ranks and pre-established relationships (i.e., Chiefs, Managers, Subordinates, and Independents, as well as Sub-Groups 1, 2, and 3).

In some embodiments, a geographic modifier may be a type of rank modifier used to determine each participant's preemption rank. A geo-fence modifier M_{GF} may be a type of geographic modifier that increases or decreases the preemption rank of those participants that are either inside or outside one or more geo-fences. As used herein, the term “geo-fence” refers to a defined geographic boundary, which may be associated with a physical or virtual boundary within a greater geographic region. A geo-fence may have a simple geometric shape (e.g., a circle, triangle, rectangle) or virtually any shape defined by the PTX administrator. For example, the geo-fence may define a circular perimeter, having a set radius from a geographical point-of-reference (e.g., FIG. 3, Area 1). Additionally and/or alternatively, the geo-fence may have an unusual shape corresponding to a boundary established by the PTX administrator (e.g., FIG. 3, Area 2). Regardless of size or shape, any participants situated inside a geo-fence may have their base rank modified accordingly.

Table 2, below, illustrates an example of preemption ranks determined using Equation 2, including both a pre-established relational modifier M_{P} and a geo-fence modifier M_{GF}. Table 2 illustrates how using weighted functions may generate a larger range of preemption ranks among the participants. When using a weighted function, a value of “1” is set for rank modifiers that do not apply to a particular participant. Participants having the predefined relationship to the current floor-holding participant (i.e., M1) have the pre-established relational modifier M_{P} (e.g., a value of x5) included in calculating their respective preemption ranks. In addition, participants inside either one of the geo-fences Area 1, Area 2 have the geo-fence modifier M_{GF} (e.g., a positive value of 10) included in calculating their respective preemption ranks. Alternatively, the geo-fence modifier M_{GF} may be applied without the pre-established relational modifier M_{P}.

TABLE 2

| Participant | R_{B} | M_{P} | M_{GF} | R_{P} |
|---|---|---|---|---|
| C1 | 10 | 5 | 1 | 50 |
| M1 (Floor) | 5 | 1 (5) | 1 | 5 (25) |
| S1-1 | 1 | 5 | 10 | 50 |
| S1-2 | 1 | 5 | 10 | 50 |
| S1-3 | 1 | 5 | 1 | 5 |
| C2 | 10 | 1 | 1 | 10 |
| M2 | 5 | 1 | 1 | 5 |
| S2-1 | 1 | 1 | 1 | 1 |
| S2-2 | 1 | 1 | 10 | 10 |
| S2-3 | 1 | 1 | 1 | 1 |
| S2-4 | 1 | 1 | 1 | 1 |
| M3 | 5 | 1 | 10 | 50 |
| S3-1 | 1 | 1 | 10 | 10 |
| S3-2 | 1 | 1 | 10 | 10 |
| I1 | 5 | 1 | 10 | 50 |
| I2 | 5 | 1 | 1 | 5 |

FIG. 4 illustrates a timeline 400 of an embodiment method of managing a group communication session using a geo-fence modifier M_{GF}. The timeline 400 demonstrates how a group communication participant's preemption rank may change based on where that participant is located in relation to one or more established geo-fences. The timeline 400 uses the same PTX group described above with regard to FIGS. 1 and 3. (e.g., communication devices 50). In addition, the same multiplicative weighted function (i.e., Equation 2), base ranks, and pre-established relational modifiers described above with regard to Table 2 are used for this embodiment. At the start of the timeline 400 (i.e., t0) the floor-holding participant is M1 and the location of the participants corresponds to that shown in FIG. 3.

At the first point t41 along the timeline 400, a non-floor-holding participant S2-1 is shown making a floor request. A server (e.g., server 120 in FIG. 1) may determine whether to grant the floor request based on the preemption rank of the floor-holding participant (e.g., MD and the requesting participant (e.g., S2-1). As demonstrated by the values in Table 2, at the first point t41, participant M1 has a higher rank (i.e., R_{P}=R_{B}(5)×M_{P}(1)×M_{GF}(1)=5) than participant S2-1 (i.e., R_{P}=R_{B}(1)×M_{P}(1)×M_{GF}(1)1), thus the floor request is denied.

At the second point t42 along the timeline 400, another non-floor-holding participant C2 is shown making a floor request. As demonstrated by the values in Table 2, participant C2 is a chief who has a much higher preemption rank (i.e., R_{P}=R_{B}(10)×M_{P}(1)×M_{GF}(1)=10) than participant M1 (i.e., R_{P}=R_{B}(5)×M_{P}(1)×M_{GF}(1)=5), thus this time the floor request may be granted, which means participant C2 is granted the floor (i.e., there is a new floor holder). This change in floor-holding participant from M1 to C2 may also change the preemption ranks of some or all participants. In particular, the participants in Group 1 (i.e., C1, S1-1, S1-2, S1-3) no longer benefit from the pre-established relational modifier M_{P}, since they do not have a pre-established relationship with the new floor-holding participant M2. Also, the other participants in Group 2 (i.e., M2, S2-1, S2-2, S2-3, S2-4) now benefit from the pre-established relational modifier M_{P}, since they have a pre-established relationship with the new floor-holding participant M2.

At the third point t43 along the timeline 400, participant S2-2 moves outside Area 2. Just prior to moving outside Area 2 participant S2-2 had one of the highest preemption ranks (e.g., R_{P}=R_{B}(1)×M_{P}(5)×M_{GF}(10)=50). However, as a result of moving outside Area 2, the preemption rank of participant S2-2 drops significantly (i.e., R_{P}=R_{B}(1)×M_{P}(5)×M_{GF}(1)=5). Immediately after moving outside Area 2, at the fourth point t44 along the timeline 400, participant S2-2 makes a floor request. Since participant S2-2 no longer benefits from the geo-fence modifier M_{GF}, participant C2 has a higher preemption rank (i.e., R_{P}=R_{B}(10)×M_{P}(1)×M_{GF}(1)=10) than participant S2-2, so the floor request is denied.

At the fifth point t45 along the timeline 400, for whatever reason, participant S2-2 moves back inside Area 2. As a result of moving inside Area 2, the preemption rank of participant S2-2 is increased to the previous rank (i.e., R_{P}=R_{B}(1)×M_{P}(5)×M_{GF}(10)=50). Immediately after moving back inside Area 2, at the sixth point t46 along the timeline 400, participant S2-2 once again makes a floor request. Since participant S2-2 now benefits from the geo-fence modifier M_{GF}, participant C2 has a lower preemption rank (i.e., R_{P}=R_{B}(10)×M_{P}(1)×M_{GF}(1)=10) than participant S2-2 (R_{P}=50). Thus, at the sixth point t46 participant S2-2 is granted the floor (i.e., there is once again a new floor holder). Subsequently, participant S2-2 will not automatically loose the floor by moving back outside Area 2, unless another participant with a higher preemption rank requests the floor.

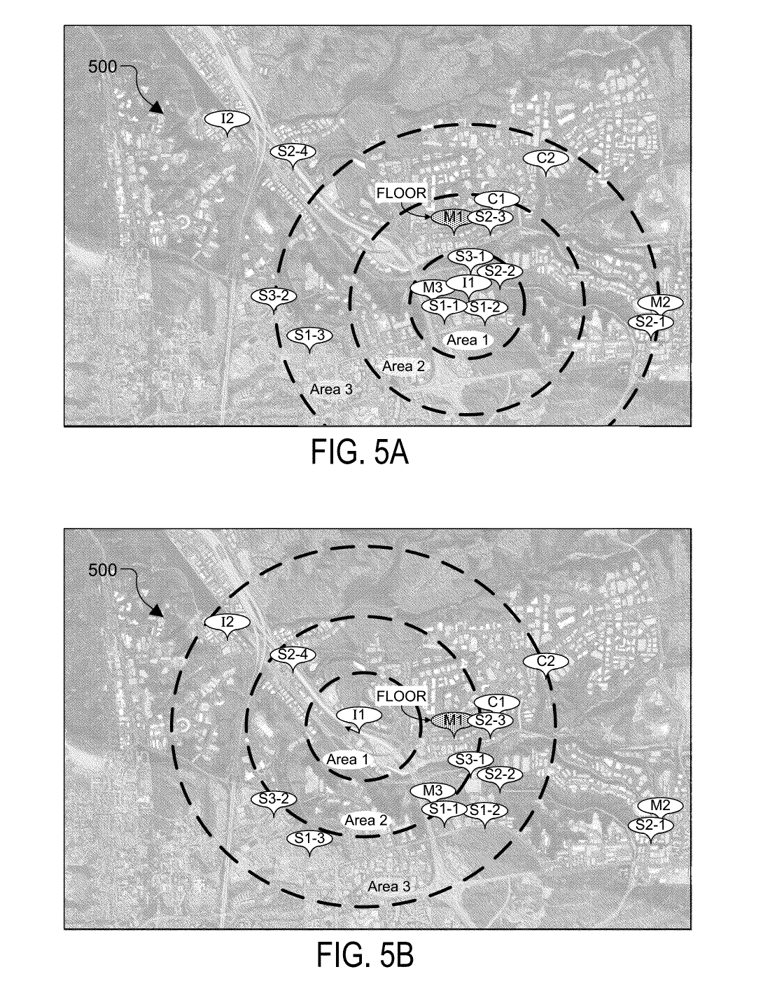

FIGS. 5A and 5B illustrate an embodiment system 500 for managing a group communication session having a floor-holding participant among a plurality of participants. Similar to FIG. 3, in FIGS. 5A and 5B an elliptical bubble with a downwardly protruding point indicates a location of each of the participants at various locations on the exemplary map. Similar to the embodiment systems 100, 300, described above with regard to FIGS. 1 and 3, each participant may access the group communication session through a communication device configured to connect to a communication network. Through shared or separate access points, each communication device may connect to the group communication session as part of the PTX group. For ease of explanation, FIGS. 5A and 5B also include the same participants described above with regard to FIGS. 1 and 3, each having similar static ranks and pre-established relationships (i.e., Chiefs, Managers, Subordinates, and Independents, as well as Groups 1, 2, and 3).

In some embodiments, a geo-centric modifier M_{GC} is another type of geographic modifier that may be used to determine each participant's preemption rank. The geo-centric modifier M_{GC} uses a geographic point-of-interest as a reference for modifying the preemption rank of participants. In this way, the closer each participant is to the point-of-interest, the higher the geo-centric modifier M_{GC} may be for that individual participant. Thus, participants may have different geo-centric modifiers depending on where they are located relative to the point-of-interest. The geo-centric modifier M_{GC} may be an inverse function of how far away each participant is from the point-of-interest.

Alternatively, less granular variations of geo-centric modifiers may be used. For example, FIGS. 5A and 5B illustrate the use three distances from a point-of-interest for attributing three different geo-centric modifiers M_{GC}. In this way, the geo-centric modifier M_{GC} may be similar to the concept of a geo-fence, but the geo-fence is defined by a perimeter having a predetermined radius from a single geographic point-of-reference. In addition, more than one radius may define concentric geo-centric fences having a common geographic point-of-reference. For example, a first geo-centric fence having a half-mile radius may define a first area of interest (e.g., FIGS. 5A and 5B, Area 1); a second geo-centric fence having a one-mile radius may define a second area of interest (e.g., FIGS. 5A and 5B, Area 2); and a third geo-centric fence having a one and a half-mile radius may define a third area of interest (e.g., FIGS. 5A and 5B, Area 3). Using the concentric geo-centric fences, a participant may receive a different geo-centric modifier M_{GC} depending upon which of the areas that participant is located.

The shared geographic point-of-interest defining the center of the geo-centric fences may be stationary or mobile. For example, the point-of-interest may be associated with a fixed landmark or a particular person of interest who is moving about. Alternatively, the location of a mobile object or a participant, such as the independent participant I1, may correspond to the point-of-interest of one or more geo-centric fences. In this way, if independent participant I1 moves, so does the center of the geo-centric fences.

The difference in location of the geo-centric fences between FIGS. 5A and 5B illustrates a point-of-interest associated with the independent participant I1. In FIG. 5A, independent participant I1 is surrounded by numerous other participants (e.g., S1-1, S1-2, S2-2, M3, S3-1), but in FIG. 5B independent participant I1 has moved toward the other independent participant I2. In this illustrative embodiment, independent participant I1 is a participant of the PTX group. Alternatively, such as in a law enforcement hot-pursuit situation, a suspect may be designated as a mobile point-of-interest (i.e., the center) of the geo-centric fences, but that suspect need not be a participant of the PTX group.

Table 3 below illustrates an example of how preemption ranks may change as a result of dynamic geo-fence locations (i.e., a mobile geo-fence point-of-reference). The values in Table 3 are determined using Equation 2, including both a pre-established relational modifier M_{P} (e.g., a value of x5 or x1, as used in Table 2) and a geo-centric modifier M_{GC}. Participants inside the concentric geo-fences Area 1, Area 2, Area 3 have the multipliers 10, 5, 2 used for their geo-centric modifiers M_{GC}, respectively, while participants outside all geo-fence rings have 1 as their multiplier. In addition, the columns corresponding to the geo-centric modifier M_{GC} and the preemption ranks M_{P} show separate values separated by a dash (“/”) corresponding to FIGS. 5A and 5B, respectively.

TABLE 3

| Participant | R_{B} | M_{P} | M_{GC} (5A/5B) | R_{P} (5A/5B) |
|---|---|---|---|---|
| C1 | 10 | 5 | 5/2 | 250/100 |
| M1 (Floor) | 5 | 1 | 5/5 | 25/25 |
| S1-1 | 1 | 5 | 10/2 | 50/10 |
| S1-2 | 1 | 5 | 10/2 | 50/10 |
| S1-3 | 1 | 5 | 2/2 | 10/10 |
| C2 | 10 | 1 | 2/2 | 20/20 |
| M2 | 5 | 1 | 1/1 | 5/5 |
| S2-1 | 1 | 1 | 2/1 | 2/1 |
| S2-2 | 1 | 1 | 10/2 | 10/2 |
| S2-3 | 1 | 1 | 5/2 | 5/2 |
| S2-4 | 1 | 1 | 1/5 | 1/5 |
| M3 | 5 | 1 | 10/5 | 50/25 |
| S3-1 | 1 | 1 | 10/2 | 10/2 |
| S3-2 | 1 | 1 | 1/2 | 1/2 |
| I1 | 5 | 1 | 10/10 | 50/50 |
| I2 | 5 | 1 | 1/2 | 5/10 |

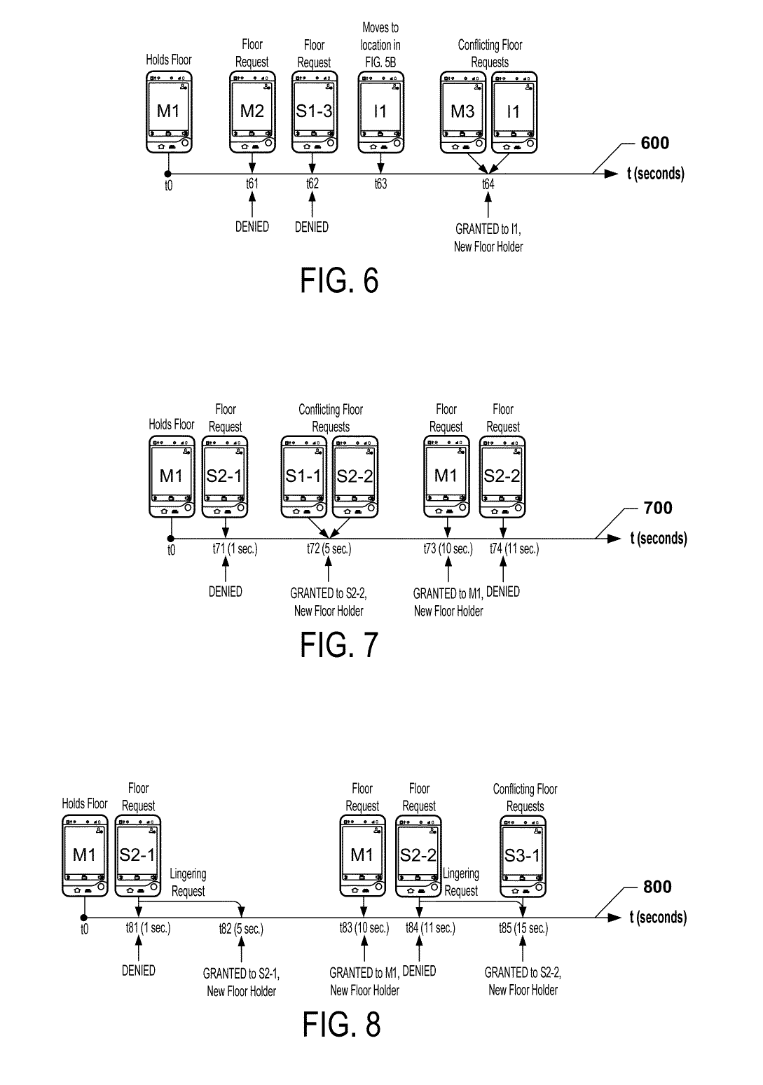

FIG. 6 illustrates a timeline 600 of an embodiment method of managing a group communication session using geo-centric modifiers M_{GC}. The timeline 600 demonstrates how a group communication participant's preemption rank may change based on a change in a geo-fence point-of-reference (i.e., dynamic geo-fences). The timeline 600 uses the same PTX group described above with regard to FIGS. 1, 3, 5A, and 5B (e.g., communication devices 50). In addition, the same weighted function (i.e., Equation 2), base ranks, and pre-established relational modifiers described above with regard to Tables 2 and 3 are used for the timeline 600. At the start of the timeline 600 (i.e., t0) the floor-holding participant is M1 and the location of each participant corresponds to that shown in FIG. 5A.

At the first point t61 along the timeline 600, a non-floor-holding participant M2, who happens to be another manager, makes a floor request. A server (e.g., server 120 in FIG. 1) may determine whether to grant the floor request based on the preemption rank of the floor-holding participant (e.g., M1) and the requesting participant (e.g., M2). As demonstrated by the FIG. 5A values in Table 3, at the first point t61, participant M1 has a higher rank (i.e., R_{P}=R_{B}(5)×M_{P}(1)×M_{GC}(5)=25) than participant M2 (i.e., R_{P}=R_{B}(5)×M_{P}(1)×M_{GF}(1)=5), thus the floor request is denied. While participant M2 holds the same base rank and participant M1, participant M2 is located just outside Area 3 and thus does not gain an increase in preemption rank based on the geo-centric modifier M_{GC}.

At the second point t62 along the timeline 600, participant S1-3 makes a floor request. While participant S1-3 is only a subordinate, participant S1-3 is a member of participant M1's group (i.e., Group 1). Once again, the server may determine whether to grant the floor request comparing preemption ranks. As demonstrated by the FIG. 5A values in Table 3, at the second point t62, participant M1 still has a higher rank (i.e., R_{P}=25) than participant S1-3 (i.e., R_{P}=R_{B}(1)×M_{P}(5)×M_{GF}(2)=10), thus the floor request is denied. While participant S1-3 is inside the outermost geo-fence Area 3, the boost from the geo-centric modifier M_{GC} (i.e., a value of x2) is not enough to outrank or even match the preemption rank of participant M1 at the second point t62.

Subsequently, at the third point t63 along the timeline 600, participant I1 moves to the location illustrated in FIG. 5B. Since participant I1 is the point-of-reference of the concentric geo-fences, the boundaries of the geo-fences move along with participant I1. The change in location of the geo-fences relative to participants may result in a change to the geo-centric modifiers M_{GC} of those participants.

At the fourth point t64 along the timeline 600, both participants M3 and I1 make conflicting floor requests. This time either requesting participants (i.e., M3 or I1) separately would have been entitled to preempt the floor from participant M1. However, because the floor requests of participants M3 and I1 conflict they must compete against each other for the floor. Thus, although participant M3 has the same preemption rank (e.g., R_{P}=R_{B}(5)×M_{P}(1)×M_{GF}(5)=25) as participant M1 (e.g., R_{P}=R_{B}(5)×M_{P}(1)×M_{GF}(5)=25), participant M3 does not have a higher preemption rank than participant I1 (e.g., R_{P}=R_{B}(5)×M_{P}(1)×M_{GF}(10)=50) who benefits from the highest geo-centric modifier M_{GC}. In this way, at point t64 participant I1 is granted the floor (i.e., there is once again a new floor holder).

In accordance with various embodiments, a further alternative geographical rank modifier may use a point-of-reference and apply a proximity rank modifier that is inversely proportional to how far away a participant is from that point-of-reference. In this way, rather than defining geo-fences or boundaries inside which the participants receive a preemption rank boost, the rank modifier may be scaled relatively based on proximity to the point-of-reference.

In some embodiments, a temporal modifier M_{T} may be a rank modifier used to determine each participant's preemption rank. The temporal modifier M_{T} may decrease the preemption rank of participants inversely proportional to a measure of time (i.e., a preemption rank decay). The time being measured may be the duration of a talk spurt (i.e., the floor-holding participant talking without a noticeable break), the duration of a floor grant, cumulative durations of either talk spurts or floor grants for a particular participant or group, or the duration of the overall group communication session. In addition, individual participants may have a temporal modifier M_{T} based on their own activity (i.e., their own talk spurs or floor grants), as well as activities of others (i.e., from the overall PTX group or through the pre-established relationships). Using a temporal modifier M_{T} based on a participant's own activity, a preemption rank of the floor-holding participant may decrease over time or start to decrease after a predetermined period. For example, a temporal modifier M_{T} may be calculated as follows:

$${M}_{T} = \frac{1}{tF} , \qquad ( Equation 3 )$$

where tF may be the duration in seconds from when the floor was granted to the current floor-holding participant. In this way, the floor-holding participant's rank will decrease inversely proportional with time, at least until someone else is granted the floor. Alternatively, a more complex function may be used for determining the temporal modifier at any given moment within the group communication session. As a further alternative, a more simple function may be used that simply reduces the floor-holding participant's preemption rank to zero after a predetermined period. These uses of temporal modifiers may deter high-ranking, long-winded speakers from monopolizing the floor. In addition, participants with a pre-established relationship to a long-winded speaker may inherit the same or similar temporal modifier M_{T}, in order to deter one group of participants from controlling the floor too long. Conversely, the temporal modifier may be used to at least initially enhance the floor-holding participant's rank. For example, by increasing the numerator in Equation 3, the temporal modifier may initially enhance a participant's preemption rank, at least until the measured duration exceeds that numerator.

Table 4 below illustrates an example of preemption ranks determined using a temporal modifier M_{T} with Equations 2 and 3, including a pre-established relational modifier M_{P}. The two values used for the temporal modifier M_{T} (1, ⅕) correspond to one second and five seconds after the floor-holding participant (i.e., M1) was granted the floor. In this illustrative example, participants having the pre-established relationship to the current floor-holding participant not only gain the pre-established relational modifier M_{P} (e.g., a value of x5) but also an inherited temporal modifier M_{T}. Alternatively, the temporal modifier M_{T} may be applied only to the floor-holding participant or without the pre-established relational modifier M_{P}.

TABLE 4

| Participant | R_{B} | M_{P} | M_{T} | R_{P} |
|---|---|---|---|---|
| C1 | 10 | 5 | 1, 1/5 | 50, 10 |
| M1 (Floor) | 5 | 1 | 1, 1/5 | 5, 1 |
| S1-1 | 1 | 5 | 1, 1/5 | 5, 1 |
| S1-2 | 1 | 5 | 1, 1/5 | 5, 1 |
| S1-3 | 1 | 5 | 1, 1/5 | 5, 1 |
| C2 | 10 | 1 | 1 | 10 |
| M2 | 5 | 1 | 1 | 5 |
| S2-1 | 1 | 1 | 1 | 1 |
| S2-2 | 1 | 1 | 1 | 1 |
| S2-3 | 1 | 1 | 1 | 1 |
| S2-4 | 1 | 1 | 1 | 1 |
| M3 | 5 | 1 | 1 | 5 |
| S3-1 | 1 | 1 | 1 | 1 |
| S3-2 | 1 | 1 | 1 | 1 |
| I1 | 5 | 1 | 1 | 5 |
| I2 | 5 | 1 | 1 | 5 |

FIG. 7 illustrates a timeline 700 of an embodiment method of managing a group communication session using a temporal modifier M_{T}. The timeline 700 demonstrates how a group communication participant's preemption rank may change with the passage of time. The timeline 700 uses the same PTX group described above with regard to FIGS. 1, 3, 5A, 5B, and 6 (e.g., communication devices 50). In addition, the same weighted function (i.e., Equation 2), base ranks, and pre-established relational modifiers described above with regard to Tables 2-4 are used for the timeline 700. At the start of the timeline 700 (i.e., t0) the floor-holding participant is participant M1.

One second after the start, at the first point t71 along the timeline 700, participant S2-1 makes a floor request. As demonstrated by the first value in Table 4 corresponding to one second after participant M1 was granted the floor, at the first point t71, participant M1 has a higher rank (i.e., R_{P}=R_{B}(5)×M_{P}(1)×M_{T}(1)=5) than participant S2-1 (i.e., R_{P}=R_{B}(1)×M_{P}(1)×M_{T}(1)=1), thus the floor request is denied.

Five seconds after the start, at the second point t72 along the timeline 700, both participants S1-1 and S2-2 make conflicting floor requests. This time either requesting participants (i.e., S1-1 or S2-2) separately would have been entitled to preempt the floor from participant M1. In addition, the conflicting floor-requesting participants at the second point t72 have the same preemption rank. In such a circumstance in this and other embodiments, when there is a tie between requesting participants, the server may consider additional factors in arbitrating the requests. For example, considering the preemption rank of participant S2-2 is not or has not been subject to the temporal modifier, like participant S1-1, the floor may be granted to participant S2-2 (i.e., there is a new floor holder).

Ten seconds after the start, at the third point t73 along the timeline 700, participant M1 makes a floor request, which is also granted. Using temporal modifiers measured from the duration of each floor grant, the temporal modifiers for the group participants at the third point t73 will look the same as they did at the start (i.e., the values reset). In this way, the floor request of participant S2-2 at the fourth point t74 (i.e., eleven seconds after the start) will result in a denial similar to what happed to participant S2-1 at the first point t71.

Since preemption ranks may change during a group communication session, such as from temporal or other rank modifiers that are dynamic, in various embodiments the floor requests may linger, when not immediately granted. In this way, following a denial of a floor request, if the denied participant later achieves a higher preemption rank than the floor-holding participant, the denied participant's earlier request may be honored and granted at that later point.

Lingering floor requests may be implemented in more than one way. In various embodiments, a denied floor request may continue to be considered an active floor request for a predetermined period following the denial. For example, with reference to FIG. 7, following either the denied floor requests of participant S2-1 at the first point t71 or participant S2-2 at the fourth point t74, if those floor requests had remained active for a predetermined period of more than 4 seconds those participants could subsequently have be granted the floor without having to re-request the floor. Alternatively, a denied floor request may linger indefinitely, but be subject to a temporal modifier. In this way, the preemption rank used at the time the lingering floor request was denied may diminish over time, so the lingering floor request may be less and less likely with time to ever be granted.

FIG. 8 illustrates a timeline 800 of an embodiment method of managing a group communication session using lingering floor requests. The timeline 800 demonstrates how a group communication participant's denied floor request may linger and later be granted. The timeline 800 uses the same PTX group described above with regard to FIGS. 1, 3, 5A, 5B, 6, and 7 (e.g., communication devices 50). In addition, the same weighted function (i.e., Equation 2), base ranks, pre-established relational modifiers, and temporal modifiers described above with regard to Table 4 are used for the timeline 800. At the start of the timeline 800 (i.e., t0) the floor-holding participant is participant M1.

One second after the start, at the first point t81 along the timeline 800, participant S2-1 makes a floor request. Similar to what happened at the first point t71 along timeline 700, the server denies this floor request. However, participant S2-1's denied floor request is allowed to linger for at least four more seconds, which corresponds to the second point t82 along the timeline 800. At that second point t82, the floor-holding participant M1's preemption rank drops from a value of 5 to a value of 1, which is now the same as the preemption rank of participant S2-1 (i.e., R_{P}=1). Thus, at the second point t82, participant S2-1's lingering floor request may be granted.

Once again similar to the timeline 700, ten seconds after the start, at the third point t83 along the timeline 800, participant M1 makes a floor request, which is also granted. Using temporal modifiers measured from the beginning of each floor grant, the temporal modifiers for the group participants at the third point t83 will look the same as they did at the start (i.e., the values reset). In this way, the floor request of participant S2-2 at the fourth point t84 (i.e., the eleven second mark) will result in a denial similar to what happed to participant S2-1 at the first point t81.

Fifteen seconds after the start, at the fifth point t85 along the timeline 800, participant S3-1 makes a floor request. Without allowing lingering floor requests, the floor request of participant S3-1 may be granted. However, by allowing lingering floor requests, there is a conflict at the fifth point t85 between participant S3-1's floor request and participant S2-2's lingering floor request. In addition, these conflicting floor requests at the fifth point t85 have the same preemption rank (i.e., R_{P}=1). In the various embodiments, when there is a tie between requesting participants, the server may consider additional factors in arbitrating the requests. For example, considering the participant S2-2 technically made the floor request first, the floor may be granted to participant S2-2 (i.e., there is a new floor holder). Alternatively, had participant S2-2's lingering floor request been subject to its own temporal modifier, participant S3-1 may have been granted the floor at the fifth point t85.

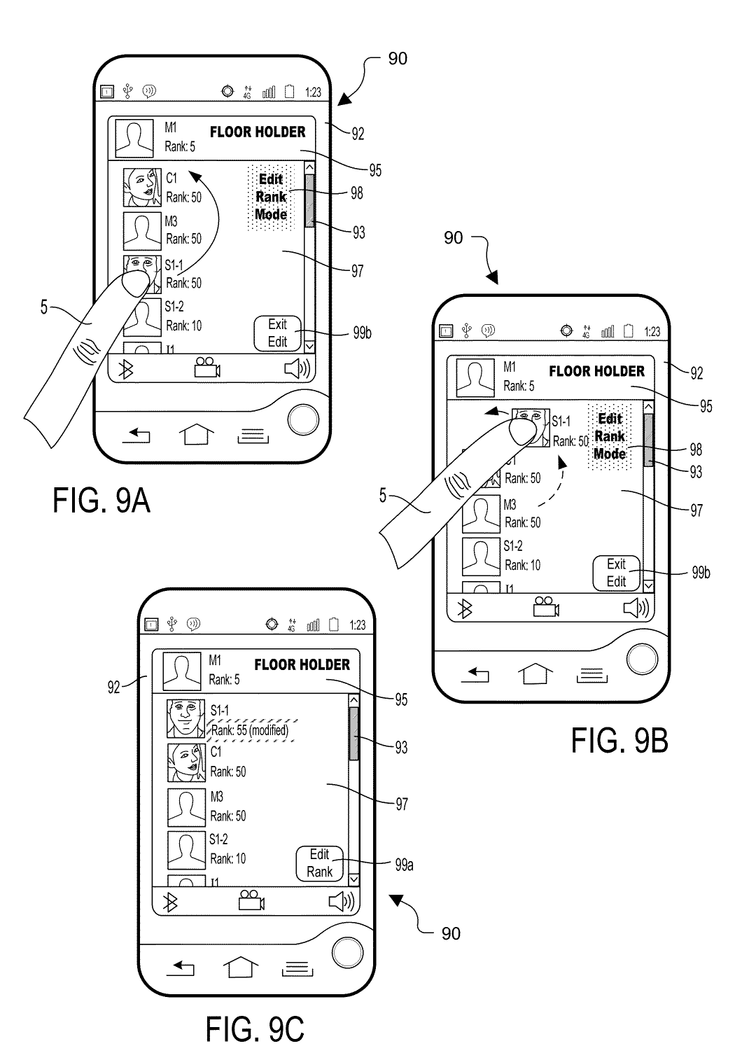

FIGS. 9A-9C illustrate a PTX administrator device 90 with a user interface for managing a group communication session using administrative relational modifiers M_{A}. The PTX administrator device 90 may be used to input an administrative relational modifier M_{A}. The PTX administrator device 90 may have a display 92 that provides the PTX administrator information about the PTX Group. For example, the display 92 may include a “FLOOR HOLDER” indication 95 that may show which group participant currently holds the floor. In addition, the PTX administrator device 90 may include a user interface 97 for making changes to participant ranks that may be input as administrative relational modifiers M_{A}. For example, the user interface 97 may be a touch-screen display that may show a current hierarchical ranking of participants. In addition, as the list of participants may not fit on the display, a scroll-bar 93 or other scrolling function(s) may be provided. As shown, the current hierarchical ranking may include a representation of each participant, including name and/or a current preemptive rank.

In FIGS. 9A-9C, icons representing PTX group participants are shown listed horizontally. Generally, the icons may appear listed in hierarchical order, with the highest preemption rank at the top. By displaying icons representing PTX group participants in this way, the PTX administrator 5 may check the accuracy or appropriateness of the calculated preemption rank order. Also, in accordance with various embodiments, the PTX administrator 5 may manually override and make changes to the preemption rank order to assign an ad hoc relationship for customizing preemption ranks.

FIGS. 9A and 9B illustrates an example of several participants having the same preemption rank (i.e., Rank: 50). As demonstrated in various embodiments, participants making floor request while having the same preemption rank as the floor-holding participant may have their floor request granted. However, when conflicting floor requests have equal preemption ranks, secondary considerations like base rank modifiers may determine the outcome of the conflict. For example, seeing the list illustrated in FIG. 9A, the PTX administrator 5 may have noticed that participant S1-1, who is a subordinate, may get out ranked by participant C1, who is a chief, or participant M3, who is a manager, even though they all share the same preemption rank. Thus, displaying information about such secondary considerations, such as a participant's title, may also assist the PTX administrator in verifying the preemption ranks are appropriate.

In various embodiments, a PTX administrator 5 may have the option to enter one or more administrative relational modifiers by simply rearranging the order in which participants appear in the user interface 97. The PTX administrator device 90 may recognize the act of holding down and sliding an icon representing a participant as a user input of an administrative relational modifier. For example in FIG. 9A, the PTX administrator 5 is selecting an icon representing participant S1-1, with the intent of moving participant S1-1 up in the preemption rank order. Recognizing that the icon representing participant S1-1 is being moved toward the top of the list (see, FIG. 9B), a processor of the PTX administrator device 90 may make room for that icon at the top of the list or anywhere else in the list by shifting the other icons. In addition to shifting the icons, the processor may take note which other participant(s) the user desires the moving participant to outrank. In this way, the processor assigns a relationship between the moving participant and an adjacent participant on the list. An administrative relational modifier may be applied to the preemption rank of the participant(s). FIG. 9C illustrates that participant S1-1 has had his preemption rank modified and is now at the top of the list. In addition, the modified preemption rank may be noted, such by highlighting or other accentuation. Options for undoing the preemption rank modification may also be made available. Alternatively, the PTX administrator 5 may be allowed to directly edit the displayed preemption rank, after which the PTX administrator device 90 may rearrange the icons accordingly and record any re-ordering that assigns an ad hoc relationship between participants.

The value of the administrative relational modifier may be a predetermined amount (e.g., 5) above or below the value of an adjacent participant in the new list position (i.e., adjusted relative to a participant to whom an ad hoc relationship is assigned). Alternatively, the administrative relational modifier may be a set percentage more or less than a participant adjacent in the list. As a further alternative, the administrative relational modifier may be a value sufficient to order a participant between other participants (i.e., more than one ad hoc relationship).

The PTX administrator 5 may be prevented from accidentally changing participant ranks, by allowing the input of administrative relational modifiers M_{A} to be entered only from an Edit Rank Mode 98. The Edit Rank Mode 98 may be entered (e.g., Edit Rank function 99a in FIG. 9C) or exited (e.g., Exit Edit function 99b in FIGS. 9A and B) through the user interface 97 or other option available on the PTX administrator device 90.

In various embodiments, another rank modifier upon which the preemption rank may be based is a group quantity modifier M_{Q}. The group quantity modifier M_{Q} may be attributed to participants associated with a select quantified characteristic of the group communication session. In this way, the group quantity modifier M_{Q} may increase or decrease the preemption rank of those participants associated with the select quantified characteristic. As used herein, a “select quantified characteristic” refers to a quantifiable feature or aspect of the PTX group that has a group characteristic threshold. The server 120 may determine when the group characteristic threshold has been reached and modify the base rank of participants of the group communication session associated with the select quantified characteristic using the group quantity modifier M_{Q}. For example, the select quantified characteristic may include a total number of group participants, sub-groups, sub-groups participants, hierarchical levels, participants assigned to one or more hierarchical levels, or participants having a certain rank.

Using a group characteristic threshold based on the total number of group communication session participants may be useful for modifying preemption parameters for PTX groups that are considered too large or too small. Larger groups may have a high frequency of floor requests, including conflicting floor requests. Conversely, small groups may have widely ranging base ranks that overly limit or prevent preemption. Thus, a threshold may be set defining when a PTX group is considered too large or too small. In addition, unlike the relational modifier, applied to individual participants, the group quantity modifier M_{Q} may be applied to all or select sets of participants. For example, a PTX group that is too large or too small may use a group quantity modifier M_{Q} that changes the base rank of all participants.

Alternatively, a group characteristic threshold based on a total number of sub-groups in the group communication session may be useful for modifying preemption parameters for PTX groups with too many or not enough sub-groups. The relational modifier M_{P} uses sub-groups to determine which group participants have a pre-established relationship to one another. Thus, without a sufficient number of sub-groups, the relational modifier may not effectively change preemption ranks. Conversely, too many sub-groups or overlapping sub-groups may reduce the effectiveness of using preemption ranks for arbitrating floor requests. Thus, a threshold may be set defining a number of sub-groups considered too many or too few. In response to determining that the number of sub-groups has reached the threshold, the group quantity modifier M_{Q} may be designed to reduce or enhance the relational modifier M_{P} applied to select groups or even all groups.

Basing the group characteristic threshold on the total number of participants within a sub-group of participants may be useful for modifying preemption parameters for sub-groups that are considered too large or too small. For example, too high a percentage of the group communication session participants being grouped within a single sub-group increase the preemption rank of too many participants. Thus, a threshold may be set defining how many participants may be included in a sub-group. Such a threshold may be a set quantify, a percentage of the whole PTX group, or another measure of the total number of sub-group participants. In response to determining that the number of sub-groups participants has reached the threshold, a group quantity modifier M_{Q} may be applied to participants of that sub-group. In this way, the group quantity modifier M_{Q} may be used to adjust the influence the relational modifier has on that or other sub-groups. For example, if the number of participants within a sub-group is too high, the server 120 may apply the group quantity modifier M_{Q} to participants of that sub-group, negating the increase otherwise received from the relational modifier M_{P}.

The group characteristic threshold may be based on various other quantifiable group characteristics. For example, the group characteristic threshold may be based on a number of base ranks (i.e., static ranks), a number of hierarchical levels, a number of participants assigned to one or more hierarchical levels, or a number of participants having a certain rank. In response to the group characteristic threshold being reached, the group quantity modifier M_{Q} may be applied to designated participants. For example, if the number of hierarchical levels in the PTX group is too low, the server 120 may apply the group quantity modifier M_{Q} in order to further distinguish participants.

The group communication session may also have more than one type of group characteristic threshold. For example, more than one of the above-noted the group characteristic thresholds may be used to trigger the application of the group quantity modifier M_{Q}. In addition, different group characteristic thresholds or combinations of group characteristic thresholds may trigger the application of different group quantity modifiers. For example, the total number of group communication session participants, as well as the total number of group communication session sub-groups may trigger application of one or more rank modifiers.

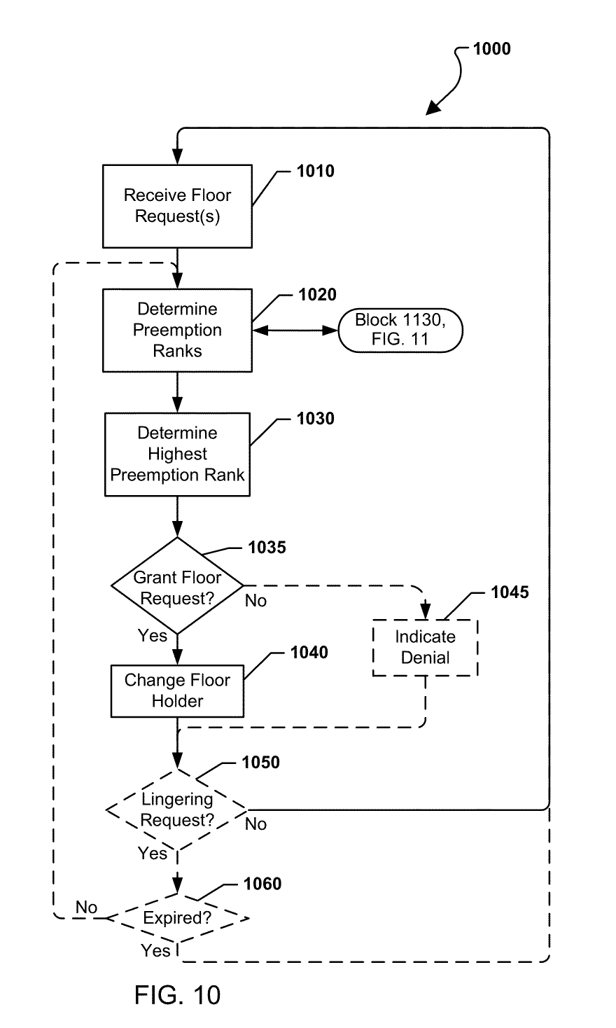

FIG. 10 illustrates an embodiment method 1000 of managing a group communication session having a floor-holding participant among a plurality of participants (i.e., a PTX group). The method 1000 may be performed by a processor, which may reside on a server (e.g., server 120 in FIG. 1), a PTX administrator device, another computing device, or a combination thereof. Implementing the method 1000, the processor may provide arbitration functions between competing demands of the plurality of participants in the group communication session.

A floor-holding participant may hold the floor until another participant with a higher preemption rank requests the floor. When one or more floor requests are received, the processor may make a determination regarding whether to grant the floor request or which one to grant if more than one is received. In block 1010, the processor may receive one or more floor requests from participants of the PTX group. The receipt of floor requests may be handled on a first-come first-serve basis, unless more than one floor request is received at the same time or within the same predetermined period (e.g., within 1 second of one another). In this way, only floor requests received simultaneously get considered.

In block 1020, the processor may determine preemption ranks for the floor-holding participant and any participant requesting the floor. To determine the preemption ranks, the processor may look up those values from a data table in memory, such as the memory used in block 1130 of method 1100 described below. Alternatively, the processor may calculate those values based on available participant information. In block 1030, the processor may determine the highest preemption rank among the preemption ranks determined in block 1020.

In determination block 1035, the processor may determine whether to grant the at least one floor request received in block 1010. In response to determining that at least one floor-requesting participant has a higher preemption rank than the floor-holding participant (i.e., determination block 1035=“Yes”), the processor may change to floor holder to the floor-requesting participant with the highest preemption rank in block 1040. Changing the floor holder may include resetting priorities in the PTX group to change which participant holds the floor, preventing the most recent floor-holding participant from being heard by the PTX group, and allowing the new floor-holding participant to be heard by the PTX group.

In response to determining that no floor-requesting participant has a higher preemption rank than the floor-holding participant, no floor request should be granted (i.e., determination block 402=“No”), the processor may transmit an indication of the denial of the floor request in optional block 1045. The indication of the denial may be an audible tone, visual indication, or other signal to the requesting participant that their floor request was denied. The denial indication is optional because requesting participants may understand that their request was denied by the fact that they did not preempt the floor from the current floor-holding participant.

In response to the change in floor request in block 1040 or the denial indication in optional block 1045, the processor may await another floor request, which may be handled returning to block 1010. Alternatively, in optional determination block 1050, the processor may determine whether a denied floor request is a lingering request. In response to determining that at least one denied floor request is a lingering request (i.e., optional determination block 1050=“Yes”), 1060 the processor may determine whether the lingering request has expired in optional determination block.

In response to determining that at least one denied floor request is a lingering request (i.e., optional determination block 1050=“No”) or that a lingering request has expired (i.e., optional determination block 1060=“No”), the processor may repeat the operations of the method 1000 upon receiving another floor request in block 1010. In response to determining that a lingering request has not expired (i.e., optional determination block 1060=“Yes”), the processor may handle the lingering request, like another floor request, by again determining preemption ranks in block 120.

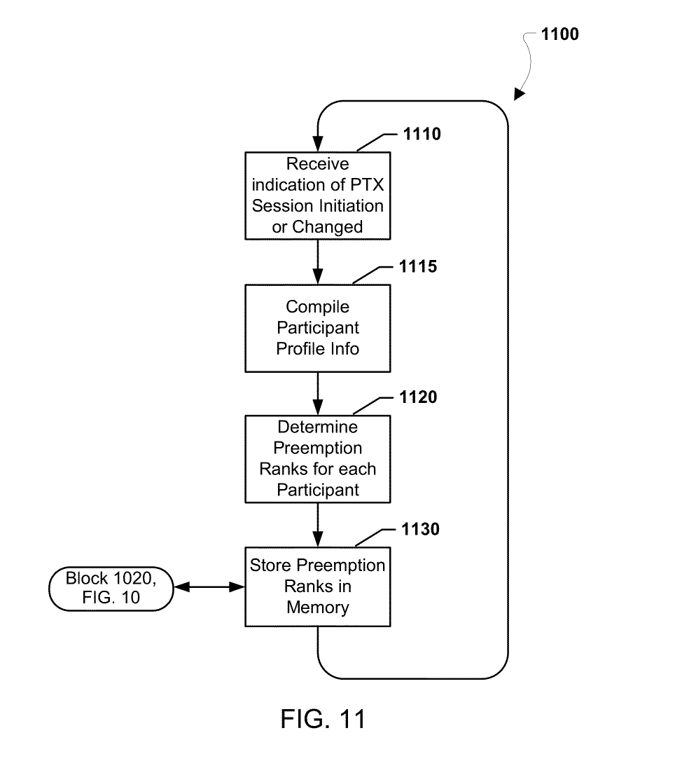

FIG. 11 illustrates an embodiment method 1100 of managing a group communication session having a floor-holding participant among a plurality of participants (i.e., a PTX group). As noted above regarding the method 1000 above, the method 1100 may be performed by a processor, which may reside on a server (e.g., server 120 in FIG. 1), a PTX administrator device, another computing device, or a combination thereof. The method 1100 enables the processor to determine preemption ranks for each of the plurality of participants in the PTX group.

In block 1110, the processor may receive an indication of a new PTX session having been initiated or a change in an existing PTX session. For example, a communication device may start a new PTX session when a PTX button or function is activated, which generates a new session request. The new session request may be received at the server, a PTX administrator device, or even an onboard processor for establishing the new PTX session. The new session request may include provisioning information necessary for establishing the PTX session, including the values for base rank and any known rank modifiers. Once the PTX session is established, the processor may receive changes effecting preemption ranks, such as in response to changes in participant or geo-fence location, administrative changes (e.g., administrative relational modifiers), or group characteristics (e.g., group quantify modifiers).

In block 1115, the processor may compile participant profile information. Compiling participant profile information may be part of a new PTX session initiation or in response to changes in the established session. Participant profile information may include contact information and values for base ranks and rank modifiers. The processor may compile the participant profile information from a database, data received along with the new or changed session indication, participants of the PTX session, or other sources. The processor may transmit a join request message to a group communications server associated with the group communication application. For example, the processor may transmit a message that requests to join an ongoing QChat session, a PTT or PTX session, or a video conference that is scheduled to start. In an embodiment, the join request message may be transmitted via Internet protocols, SMS (or MMS) text message, email, short-range wireless signals (e.g., Bluetooth, etc.), and/or via a proprietary message format associated with the group communication application and/or the group communications server. Further, the join request message may include various data required to verify or authorize the communication device (and its user) to the group communications server. For example, the join request message may include credentials, such as passwords, user IDs, phone numbers, MAC addresses, secret keys, and/or login identities, and further may be encrypted or obscured. In various embodiments, the join request message may include credentials stored within the communication device including base ranks and/or the identification of pre-established relationships.

In block 1120, the processor may determine preemption ranks for each participant of the PTX group. The processor may determine the preemption ranks using the compiled participant profile information and a predetermined function for calculating preemption ranks (e.g., Equations 2 or 3). In addition, the preemption rank determination may be based on one or more rank modifiers, including a pre-established relational modifier or an administrative relational modifier. The pre-established relational modifier may be based on whether an individual participant for which the preemption rank is determined has a pre-established relationship to the floor-holding participant. The administrative relational modifier may be received from an administrative participant of the plurality of participants, which establishes a relationship between an individual participant for which the preemption rank is determined and another participant among the plurality of participants.

In block 1130, the processor may store the determined preemption ranks in memory, which may reside locally, such as an onboard memory of one or more communication devices or an accessible database (e.g., database 125 in FIG. 1). Once stored in the memory, the values of the preemption ranks may be used by the processor, such as in block 1020 of method 1000 as described above. The processor may repeat the operations of the method 1100 upon receiving further indications of changes in the PTX session in block 1110.

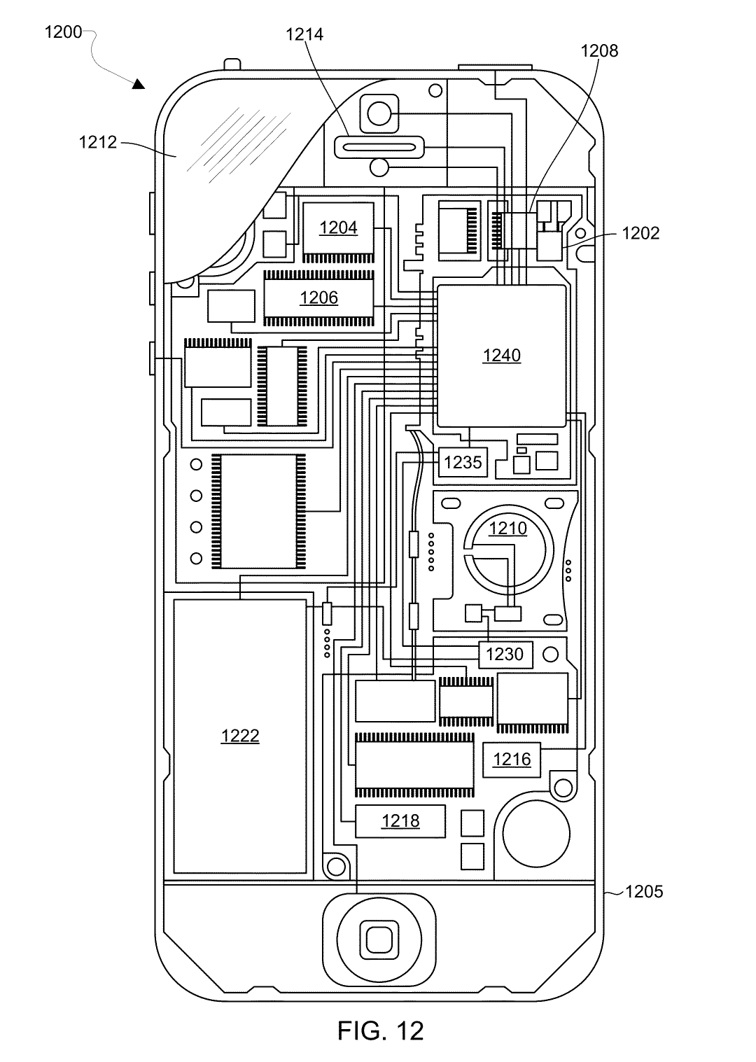

The various embodiments (including, but not limited to, embodiments described above with reference to FIGS. 1-11) may be implemented in and/or with any of a variety of communication devices, an example of which is illustrated in FIG. 12 in the form of a cellular telephone. In this way, the rechargeable computing device in various embodiments may be a rechargeable computing device as illustrated in FIG. 12 and as described below. In various embodiments, the rechargeable computing device 1200 may include a power receiver 1210, a programmable logic circuit 1230, a reset switch 1235, and a processor 1240. In addition, in various embodiments the processor 1240 of the rechargeable computing device 1200 may be coupled to a touch-screen controller 1204 and an internal memory 1206. The processor 1240 may be one or more multicore ICs designated for general or specific processing tasks. The internal memory 1206 may be volatile or non-volatile memory such as NAND, and may be secure and/or encrypted memory, or unsecure and/or unencrypted memory, or any combination thereof.

The processor 1240 may be coupled to a touch-screen controller 1204. The touch-screen controller 1204 and the processor 1240 may also be coupled to a touch-screen panel 1212, such as a resistive-sensing touch-screen, capacitive-sensing touch-screen, infrared sensing touch-screen, etc. Alternatively, the various embodiments may be implemented in and/or with any of a variety of devices that do not include a touch-screen controller, touch-screen or any form of screen or direct data interface, such as a data card, wireless hotspot device, network component, peripheral memory device or similar “headless” devices.

The rechargeable computing device 1200 may have at least one radio signal transceiver 1208 (e.g., Peanut®, Bluetooth®, Zigbee®, Wi-Fi, RF radio) and antennae 1202, for sending and receiving, coupled to each other and/or to the processor 1240. The radio signal transceiver 1208 and antennae 1202 may be used with the above-mentioned circuitry to implement the various wireless transmission protocol stacks and interfaces. The rechargeable computing device 1200 may include a cellular network wireless modem chip 1216 coupled to the processor that enables communication via a cellular network.

The rechargeable computing device 1200 may include a peripheral device connection interface 1218 coupled to the processor 1240. The peripheral device connection interface 1218 may be singularly configured to accept one type of connection, or multiply configured to accept various types of physical and communication connections, common or proprietary, such as USB, FireWire, Thunderbolt, or PCIe. The peripheral device connection interface 1218 may also be coupled to a similarly configured peripheral device connection port (not shown).

The rechargeable computing device 1200 may also include speakers 1214 for providing audio outputs. The rechargeable computing device 1200 may also include a casing 1205, constructed of a plastic, metal, or a combination of materials, for containing all or some of the components discussed herein. The rechargeable computing device 1200 may include an onboard battery 1222 coupled to the processor 1240, such as a battery with power disconnect in accordance with various embodiments herein. The onboard battery 1222 may also be coupled to the peripheral device connection port to receive a charging current from a source external to the rechargeable computing device 1200.

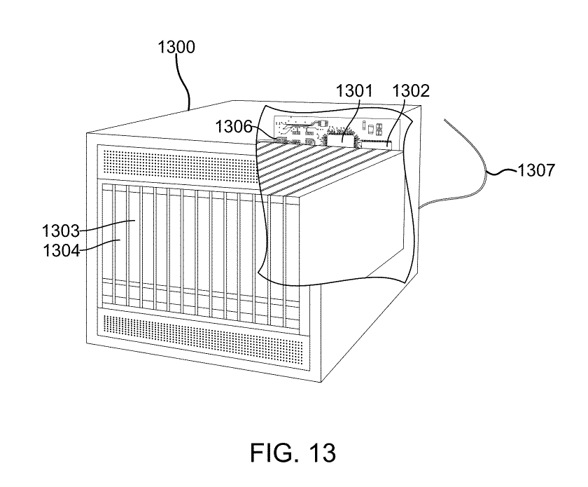

The various embodiments may be implemented on any of a variety of commercially available server devices, such as the server computing device 1300 illustrated in FIG. 13. Such a server computing device 120 typically includes a processor 1301 coupled to volatile memory 1302 and a large capacity nonvolatile memory, such as a disk drive 1303. The server computing device 120 may also include a floppy disc drive, compact disc (CD) or DVD disc drive 1306 coupled to the processor 1301. The server computing device 120 may also include network access ports 1304 (or network interfaces) coupled to the processor 1301 for establishing data connections with a network 1305, such as a local area network coupled to other broadcast system computers and servers.

The processors in the various embodiments described herein, including the programmable logic circuit, may be any programmable microprocessor, microcomputer or multiple processor chip or chips that can be configured by instructions (i.e., software instructions, such as applications) to perform a variety of functions, including the functions of the various embodiments described above. In some devices, multiple processors may be provided, such as one processor dedicated to wireless communication s and one processor dedicated to running other applications. Typically, before being accessed and loaded into the processors, software applications may be stored in the internal memory. The processors may include internal memory sufficient to store the application instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processor themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory computer-readable or server-readable medium or a non-transitory processor-readable storage medium. The steps of a method or algorithm disclosed herein may be embodied in a processor-executable software module which may reside on a tangible, non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A method of managing a group communication session among a plurality of participants, comprising:
determining, for each participant of the plurality of participants in a group communication session, a preemption rank for preempting a floor from a floor-holding participant based on a rank modifier including
a pre-established relational modifier based on whether an individual participant for which the preemption rank is determined has a pre-established relationship to the floor-holding participant, wherein the individual participant having the pre-established relationship to the floor-holding participant increases the preemption rank of the individual participant while the floor-holding participant holds the floor of the group communication session;
receiving a floor request from a requesting participant of the plurality of participants that is not the floor-holding participant;
determining whether to grant the floor request based on the preemption rank of the floor-holding participant and the requesting participant; and
transmitting a request response in response to determining to grant the floor request.

2. (canceled)

3. The method of claim 1, wherein the preemption rank is further based on a geographic modifier based on a location of the individual participant for which the preemption rank is determined.

4. The method of claim 1, wherein the preemption rank is further based on a geographic modifier determined by a location of the floor-holding participant.

5. The method of claim 1, wherein the preemption rank is based on whether the individual participant for which the preemption rank is determined has the pre-established relationship to the floor-holding participant, wherein the preemption rank of the individual participant having the pre-established relationship to the floor-holding participant is inversely proportional to a duration the floor-holding participant holds the floor of the group communication session.

6. The method of claim 1, wherein the preemption rank of the individual participant for which the preemption rank is determined is inversely proportional to a duration the individual participant holds the floor of the group communication session.

7. The method of claim 1, wherein the preemption rank of the individual participant for which the preemption rank is determined is not modified by the pre-established relational modifier.

8. The method of claim 31, wherein the administrative relational modifier changes the preemption rank of the individual participant for which the preemption rank is determined by a weighted function based on the preemption rank of another participant among the plurality of participants.

9. The method of claim 31, wherein the preemption rank is based on the administrative relational modifier received while the group communication session is in progress.

10. The method of claim 1, wherein the preemption rank is further based on a group quantity modifier, wherein the group quantify modifier is based on a quantity selected from the group including a total number of the plurality of participants, a number of participants in a sub-group of the plurality of participants, a number of sub-groups among the plurality of participants, a number of base ranks, a number of participants having a particular base rank, and a number of participants having a particular preemption rank.

11. A server, comprising:
a memory; and
a processor coupled to the memory and configured with processor-executable instructions to perform operations comprising:
determining, for each participant of a plurality of participants in a group communication session, a preemption rank for preempting a floor from a floor-holding participant based on a rank modifier including
a pre-established relational modifier based on whether an individual participant for which the preemption rank is determined has a pre-established relationship to the floor-holding participant, wherein the individual participant having the pre-established relationship to the floor-holding participant increases the preemption rank of the individual participant while the floor-holding participant holds the floor of the group communication session;
receiving a floor request from a requesting participant of the plurality of participants that is not the floor-holding participant;
determining whether to grant the floor request based on the preemption rank of the floor-holding participant and the requesting participant; and
transmitting a request response in response to determining to grant the floor request.

12. (canceled)

13. The server of claim 11, wherein the processor is configured with processor-executable instructions to perform operations such that the preemption rank is further based on a geographic modifier based on a location of the individual participant for which the preemption rank is determined.

14. The server of claim 11, wherein the processor is configured with processor-executable instructions to perform operations such that the preemption rank is further based on a geographic modifier determined by a location of the floor-holding participant.

15. The server of claim 11, wherein the processor is configured with processor-executable instructions to perform operations such that the preemption rank is based on whether the individual participant for which the preemption rank is determined has the pre-established relationship to the floor-holding participant, wherein the preemption rank of the individual participant having the pre-established relationship to the floor-holding participant is inversely proportional to a duration the floor-holding participant holds the floor of the group communication session.

16. The server of claim 11, wherein the processor is configured with processor-executable instructions to perform operations such that the preemption rank of the individual participant for which the preemption rank is determined is inversely proportional to a duration the individual participant holds the floor of the group communication session.

17. The server of claim 11, wherein the processor is configured with processor-executable instructions to perform operations such that the preemption rank of the individual participant for which the preemption rank is determined is not modified by the pre-established relational modifier.

18. The server of claim 32, wherein the processor is configured with processor-executable instructions to perform operations such that the administrative relational modifier changes the preemption rank of the individual participant for which the preemption rank is determined by a weighted function based on the preemption rank of another participant among the plurality of participants.

19. The server of claim 32, wherein the processor is configured with processor-executable instructions to perform operations such that the preemption rank is based on the administrative relational modifier received while the group communication session is in progress.

20. The server of claim 11, wherein the processor is configured with processor-executable instructions to perform operations such that the preemption rank is further based on a group quantity modifier, wherein the group quantify modifier is based on a quantity selected from the group including a total number of the plurality of participants, a number of participants in a sub-group of the plurality of participants, a number of sub-groups among the plurality of participants, a number of base ranks, a number of participants having a particular base rank, and a number of participants having a particular preemption rank.

21. A non-transitory processor-readable storage medium having stored thereon processor-executable software instructions configured to cause a processor of a server to perform operations comprising:
determining, for each participant of a plurality of participants in a group communication session, a preemption rank for preempting a floor from a floor-holding participant based on a rank modifier including
a pre-established relational modifier based on whether an individual participant for which the preemption rank is determined has a pre-established relationship to the floor-holding participant, wherein the individual participant having the pre-established relationship to the floor-holding participant increases the preemption rank of the individual participant while the floor-holding participant holds the floor of the group communication session;
receiving a floor request from a requesting participant of the plurality of participants that is not the floor-holding participant;
determining whether to grant the floor request based on the preemption rank of the floor-holding participant and the requesting participant; and
transmitting a request response in response to determining to grant the floor request.

22. (canceled)

23. The non-transitory processor-readable storage medium of claim 21, wherein the stored processor-executable instructions are configured to cause the processor to perform operations such that the preemption rank is further based on a geographic modifier based on a location of the individual participant for which the preemption rank is determined.

24. The non-transitory processor-readable storage medium of claim 21, wherein the stored processor-executable instructions are configured to cause the processor to perform operations such that the preemption rank is further based on a geographic modifier determined by a location of the floor-holding participant.

25. The non-transitory processor-readable storage medium of claim 21, wherein the stored processor-executable instructions are configured to cause the processor to perform operations such that the preemption rank is based on whether the individual participant for which the preemption rank is determined has the pre-established relationship to the floor-holding participant, wherein the preemption rank of the individual participant having the pre-established relationship to the floor-holding participant is inversely proportional to a duration the floor-holding participant holds the floor of the group communication session.

26. The non-transitory processor-readable storage medium of claim 21, wherein the stored processor-executable instructions are configured to cause the processor to perform operations such that the preemption rank of the individual participant for which the preemption rank is determined is inversely proportional to a duration the individual participant holds the floor of the group communication session.

27. The non-transitory processor-readable storage medium of claim 21, wherein the stored processor-executable instructions are configured to cause the processor to perform operations such that the preemption rank of the individual participant for which the preemption rank is determined is not modified by the pre-established relational modifier.

28. The non-transitory processor-readable storage medium of claim 33, wherein the stored processor-executable instructions are configured to cause the processor to perform operations such that the administrative relational modifier changes the preemption rank of the individual participant for which the preemption rank is determined by a weighted function based on the preemption rank of another participant among the plurality of participants.

29. The non-transitory processor-readable storage medium of claim 33, wherein the stored processor-executable instructions are configured to cause the processor to perform operations such that the preemption rank is based on the administrative relational modifier received while the group communication session is in progress.

30. A server, comprising:
means for determining, for each participant of a plurality of participants in a group communication session, a preemption rank for preempting a floor from a floor-holding participant based on a rank modifier including
a pre-established relational modifier based on whether an individual participant for which the preemption rank is determined has a pre-established relationship to the floor-holding participant, wherein the individual participant having the pre-established relationship to the floor-holding participant increases the preemption rank of the individual participant while the floor-holding participant holds the floor of the group communication session;
means for receiving a floor request from a requesting participant of the plurality of participants that is not the floor-holding participant;
means for determining whether to grant the floor request based on the preemption rank of the floor-holding participant and the requesting participant; and
means for transmitting a request response in response to determining to grant the floor request.

31. The method of claim 1, wherein the rank modifier modifying the preemption rank may include an administrative relational modifier based on an assigned relationship between the individual participant for which the preemption rank is determined and another participant among the plurality of participants.

32. The server of claim 11, wherein the processor is configured with processor-executable instructions to perform operations such that the rank modifier modifying the preemption rank may include an administrative relational modifier based on an assigned relationship between the individual participant for which the preemption rank is determined and another participant among the plurality of participants.

33. The non-transitory processor-readable storage medium of claim 21, wherein the stored processor-executable instructions are configured to cause the processor to perform operations such the rank modifier modifying the preemption rank may include an administrative relational modifier based on an assigned relationship between the individual participant for which the preemption rank is determined and another participant among the plurality of participants.
